(19) United States
(12) Patent Application Publication
(10) Pub. No.: US 2025/0221423 A1
(43) Pub. Date: Jul. 10, 2025

(54) TABLET AND METHOD FOR MANUFACTURING THE SAME

(71) Applicant: IVAN MALLINOWSKI, Wassenberg (DE)

(72) Inventor: IVAN MALLINOWSKI, Wassenberg (DE)

(21) Appl. No.: 19/094,880

(22) Filed: Mar. 29, 2025

Related U.S. Application Data
(63) Continuation of application No. PCT/EP2023/059877, filed on Apr. 17, 2023.

(30) Foreign Application Priority Data
May 19, 2022 (DE) 102022112627.7

(51) Int. Cl. A23C 1/14; A23C 11/10

(52) U.S. Cl. CPC A23C 1/14; A23C 11/103

(57) ABSTRACT

A method for producing a tablet configured to be combined with water to produce a milk substitute beverage, the method comprising: pressing plant parts of real nuts, kernels, cereals, and/or other seeds into a shape of the tablet, wherein a major portion of the plant parts is provided as lumps with a lump size exceeding 1 mm; and drying the tablet, so that vitamins and nutrients are preserved in the plant parts

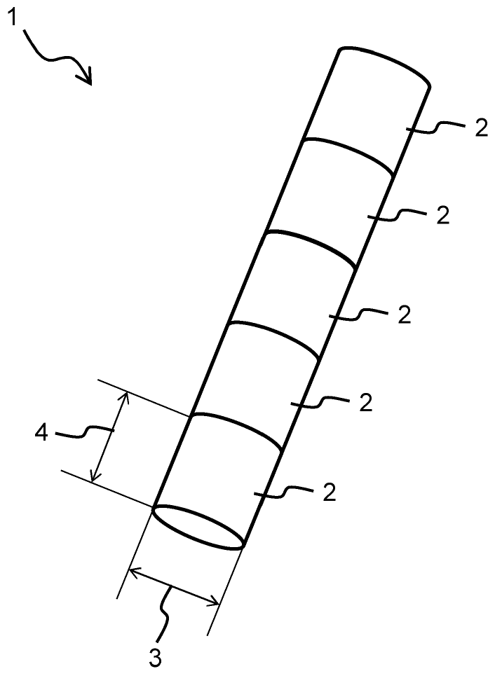

### RELATED APPLICATIONS

This application is a continuation of International patent application PCT/EP2023/059877, filed on Apr. 17, 2023, claiming priority from German patent application DE 10 2022 112 627.7, filed on May 19, 2022, both of which are incorporated in their entireties by this reference.

### FIELD OF THE INVENTION

The invention relates to a tablet including pressed and dried plant components of genuine nuts, kernels, cereals, and/or other seeds, wherein the tablet is configured to be combined with water to form a milk substitute product. The invention also relates to a method for producing the tablet.

### BACKGROUND OF THE INVENTION

Milk replacement products also designated as plant based milk are well known and based on cereals (spelts, oats, rice, Kokkoh), legumes (lupine, soy), nuts, and kernels (coconut meat, almonds, hazelnut, walnut) and seeds (buckwheat, horchata).

DE 2021 001498U1 proposes a tablet made from pressed oat flour in order to facilitate dosing compared to powdered material and in order to improve storability. The powder dissolves the macroscopic structure so that the contents of the cereal are distributed in water easily.

DE 10 2015 011 167 A1 and EP 2 906 095 B1 disclose capsules including plant parts and are configured for producing beverages. EP 3 185690 B1 discloses an instant milk powder tablet. Vitamins and nutrients of the plant parts degrade in the flour already a few hours after grinding.

### BRIEF SUMMARY OF THE INVENTION

Thus, it is an object of the invention to retain vitamins and nutrients of the plant parts.

Improving upon the known method, it is proposed according to the invention to press the plant parts into lumps, thus to a particle size in excess of 1 mm. Freshness of the plant parts and vitamins and nutrients included therein are thus essentially maintained. The tablet has to be mechanically comminuted in order to produce the beverage.

Lumps are discrete parts with an original macroscopic structure of the plant parts, in particular, with at least some particle sizes in a millimeter range and greater. Lumps, according to the invention, are whole or shredded nuts, kernels, cereal grains, and other seeds.

Advantageously, the method according to the invention air dries the plant parts. Air drying saves valuable natural ingredient substances of the plant parts. Alternatively, other drying methods, in particular, freeze drying, can be used. Freeze drying significantly shortens the drying process.

Advantageously, at least some of the plant parts are soaked in water before drying according to the method according to the invention. The plant parts swell in the pulp thus created and can therefore be processed more easily. The swelling can be supported by heating the pulp to 50-60 degrees C.

The plant parts are advantageously dried in an inert atmosphere, in particular under nitrogen in a method according to the invention. Thus, the introduction of germs into the plant parts during the drying is prevented.

Advantageously, at least some of the plant parts are shredded before pressing according to the method according to the invention. This accelerates precise portioning, in particular, of large nuts, kernels, cereals or seeds and accelerates comminution when producing the beverage. Alternatively at least some entire nuts, kernels, cereal grains, and other seeds can be included in portions of the tablet.

Advantageously, at least a portion of the plant parts is decomposed before pressing. Thus, insoluble contents of the plant parts are modified so that they distribute in water more easily. The plant parts can be steamed, roasted, germinated, or fermented in order to decompose them.

Advantageously, at least a portion of the plant parts is sweetened before pressing according to the method according to the invention. This improves the taste of the beverage. In particular, starch and long-chain sugars, like glucose, can be decomposed by enzymes in the plant parts and converted into short-chain sugars like fructose.

Improving upon a known tablet, it is proposed according to the invention that the plant parts are provided in the tablet to a major extent as lumps, thus with a particle size above 1 mm. The tablet is produced according to the method according to the invention and is characterized by the advantages recited supra.

Advantageously, a binder is added to the tablet according to the invention. Thus, shape retention of the tablet is improved after drying. Plant binders, like starch or guar flour, are particularly suitable.

Advantageously, an emulgator is added to the tablet according to the invention. Thus, a de-mixing of the beverage is prevented. Lecithin is particularly suitable as an emulgator.

Oil is advantageously added to a tablet according to the invention. The oil forms an emulsion together with the water and feels very similar to natural animal milk. The oil can be mixed with the plant parts or worked into the tablet in one or plural capsules which are mechanically comminuted together with the plant parts when producing the beverage according to the invention.

Advantageously, sweetener and/or salt is added to the tablet according to the invention. In particular, sugar or other sugar-free sweeteners can be used. Sugar and salt improve storability of the tablet and also function as a taste enhancer in the tablet.

The tablet, according to the invention, advantageously includes a moisture-repelling shell. The shell prevents absorption of moisture from the ambient air and improves storability of the tablet.

The shell can be made in particular from a sufficiently firm wax or fat, e.g., palm fat.

The tablet according to the invention is initially mechanically comminuted and soaked in water to produce the beverage. Only mechanical comminution, e.g., grinding up the tablet according to the invention, dissolves the macroscopic structure of the plant parts so that their content substances distribute in water easily.

Further advantageously, the water is pressed through the pulp being generated according to the method according to the invention. Thereafter, the beverage essentially only includes the contents of the plant parts that float in water and the parts that are not retained by the pulp.

Advantageously, plural tablets according to the invention are stacked into a roll and wrapped in foil to form a packaged unit. This facilitates handling the tablets in a commercial environment, in particular the tablets can be wrapped in paper.

### BRIEF DESCRIPTION OF THE DRAWINGS

The invention is now described based on an advantageous embodiment with reference to

a drawing FIGURE showing a packaging unit 1 according to the invention including tablets 2 according to the invention.

### DETAILED DESCRIPTION OF THE INVENTION

The packaging unit 1 according to the invention shown in the drawing FIGURE includes five circular cylindrical tablets 2 according to the invention. Each tablet 2 has a diameter 3 and a height 4 of 3.5 cm and a weight of approximately 33 g.

30 g of oats provided in whole kernels are soaked in water and mixed with a and β amylase at a temperature of 58 degrees C. to 65 degrees C. in order to produce a tablet 2. This swells the kernels, and the starch obtained is partially converted into maltose and then into glucose. Thus, the tablet 2 includes 13 g of sugar.

Thereafter, lecithin and salt are mixed into the plant parts, and the mass thus created is molded into a shape of the tablet 2 and dried to a residual humidity of 12.5% in a warm nitrogen flow.

After the drying, five tablets 2 are respectively wrapped in wax paper to form the packaging unit 1.

The tablet 2 is then retrieved from the packaging unit 1 and pureed in order to produce a beverage portion of a milk substitute product, then 0.25 l of water is pressed through the puree. The filter cake remaining on the filter is discarded thereafter.

### REFERENCE NUMERALS AND DESIGNATIONS

1 packaging unit
2 tablet
3 diameter
4 height

What is claimed is:

1. A method for producing a tablet configured to be combined with water to produce a milk substitute beverage, the method comprising:
pressing plant parts of real nuts, kernels, cereals, and/or other seeds into a shape of the tablet, wherein a major portion of the plant parts is provided as lumps with a lump size exceeding 1 mm; and
drying the tablet.

2. The method according to the to claim 1, wherein the tablet is air-dried.

3. The method according to claim 1, coarse shredding at least a portion of the plant parts before the pressing.

4. The method according to claim 1, further comprising: decomposing at least a portion of the plant parts before the pressing.

5. The method according to claim 1, further comprising: sweetening at least a portion of the plant parts before the pressing.

6. A tablet made from pressed and dried plant parts from real nuts, kernels, cereals and/or other seeds configured to produce a milk replacement product when combined with water,
wherein a majority of the plant parts in the tablet is provided in lumps with a lump size exceeding 1 mm.

7. The tablet according to the claim 6, further comprising:
binder;
emulgator;
oil;
sweetener, and/or
salt.

8. The tablet according to claim 7, further comprising: a moisture repelling shell.

9. A method for producing a milk-like beverage including water, the method comprising:
mechanically comminuting the tablet according to claim 6 to form a comminuted tablet;
soaking the comminuted tablet in water to form a pulp; and
pressing the water through the pulp to form the milk-like beverage.

10. A packaging unit including plural tablets according to claim 6 stacked in a roll shape and wrapped in paper.
